(19) United States
(12) Patent Application Publication
(10) Pub. No.: US 2008/0030770 A1
(43) Pub. Date: Feb. 7, 2008

(54) Data outputting system and output controlling server of the same

(75) Inventors: Daiki Nishioka, Tokyo (JP); Tomoyuki Ishii, Tokyo (JP); Tomohiro Iwase, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/600,188

(22) Filed: Nov. 16, 2006

(30) Foreign Application Priority Data
Aug. 7, 2006 (JP) JP2006-215055

(51) Int. Cl. G06F 3/12

(52) U.S. Cl. 358/1.15

(57) ABSTRACT

There is described a data outputting system and an output controlling server, in which operations for the job already introduced in the system, such as a changing operation of the output destination of the job, etc., can be achieved by a simple operation conducted by the user. The server includes a communication section to receive a job and an output instruction, a storage to store the job received by the communication section while correlating the job with output destination information and a control section to control managing and communicating operations of the job. The control section controls a transferring operation for transferring the job to the specific output apparatus, corresponding to a time when an implementation for processing the job is enabled in the specific output apparatus represented by the output destination information, which is correlated with the job stored in the storage.

This application is based on Japanese Patent Application No. 2006-215055 filed on Aug. 7, 2006 in Japanese Patent Office, the entire content of which is hereby incorporated by reference.

### BACKGROUND OF THE INVENTION

The present invention relates to a data outputting system and an output controlling server, in which a data transferring operation from an information terminal device to an output apparatus is conducted through the output controlling server coupled to the network.

In an environment in which a lot of output apparatuses, such as a printer, a copier, a facsimile, or the like, and a lot of information processing terminal devices, such as a personal computer, etc., are coupled to each other through a network, such as a LAN (Local Area Network) equipped in the business working area, etc., it is possible for each of the information processing terminal-devices to use an arbitrary one of the output apparatuses for conducting a printing job, a facsimile transmitting job or the like. However, associating with the scale expansion of the network environment, when employing the conventional method in which a desired output apparatus is selected from a list of apparatus names, etc., it becomes difficult for the user to grasp what apparatus name corresponds to each of the output apparatuses within the business working area. As a result, there have been inconveniences that the output operation is conducted by an output apparatus equipped in a wrong site, which is not selected by the user, etc.

To eliminate such the inconveniences, there has been proposed an apparatus designating system in which the arrangement of the apparatuses in the network is indicated by displaying a layout screen with icons each of which corresponds to each of the apparatuses and is displayed at a position, corresponding to each of the real sites at which the apparatuses are respectively equipped, on the layout screen, and by designating the desired icon, it is possible for the user to select the apparatus corresponding to the selected icon as the apparatus for executing the job (for instance, set forth in Tokkaihei 10-320344 Japanese Non-Examined Patent Publication).

According to the conventional technology mentioned in the above, although, by selecting the specific icon displayed on the layout screen, it is possible for the user to introduce a printing job, etc. into the designated output apparatus, there has been a fear that the currently introduced printing job could not be executed for a long time, if a lot of other preceding jobs happen to be reserved in the output apparatus designated by the user, or the output apparatus is still in a standby state due to a malfunction, caused by a jam, etc., occurring in a mid cause of executing the previous job. In the abovementioned situation, the user, would wish to change the currently designated output apparatus to another output apparatus. However, since the data for the job are already transmitted to the currently designated output apparatus and in a state of waiting the output operation, the only way, for the user to avoid the above problem by changing the output destination of the data, is to once delete the introduced job from the currently designated output apparatus, and then, introduce the same job again into another output apparatus. This has force the user to conduct cumbersome operations including deletion of the job and reintroduction of the job, resulting in increase of user's stress.

### SUMMARY OF THE INVENTION

To overcome the abovementioned drawbacks in conventional data outputting systems and output controlling servers, it is an object of the present invention to provide a data outputting system and an output controlling server, in which operations for the job already introduced in the system, such as a changing operation of the output destination of the job, etc., can be achieved by a simple operation conducted by the user.

Accordingly, to overcome the cited shortcomings, the abovementioned object of the present invention can be attained by an output controlling server and a data outputting system described as follow.
(1) An output controlling server, to which an information processing terminal device and a plurality of output apparatuses are coupled through a network, comprising: a communication section to receive a job and an output instruction for designating a specific output apparatus, being one of the plurality of output apparatuses, as an output destination of the job from the information processing terminal device; a storage to store the job received by the communication section while correlating the job with output destination information representing the specific output apparatus designated by the output instruction; and a control section to control managing and communicating operations of the job; wherein the control section controls a transferring operation for transferring the job to the specific output apparatus, corresponding to a time when an implementation for processing the job is enabled in the specific output apparatus represented by the output destination information, which is correlated with the job stored in the storage.
(2) A data outputting system, comprising: an information processing terminal-device; a plurality of output apparatuses; and an output controlling server; wherein the information processing terminal device, the plurality of output apparatuses and the output controlling server are coupled to each other through a network; and wherein the information processing terminal device includes: a first communication section to transmit a job and an output instruction for designating a specific output apparatus, being one of the plurality of output apparatuses, as an output destination of the job to the output controlling server; while, the output controlling server includes: a second communication section to receive the job and the output instruction from the information processing terminal device; a storage to store the job received by the second communication section while correlating the job with output destination information representing the specific output apparatus designated by the output instruction; and a control section to control managing and communicating operations of the job; and wherein the control section controls a transferring operation for transferring the job to the specific output apparatus, corresponding to a time when an implementation for processing the job is enabled in the specific output apparatus represented by the output destination information, which is correlated with the job stored in the storage.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an exemplified configuration of a data outputting system embodied in the present invention;

FIG. 2 shows a main functional configuration of a data outputting system embodied in the present invention as a first embodiment;

FIG. 3 shows an explanatory schematic diagram indicating an example of an output operating screen to be displayed on a display device of an information processing terminal device when instructing a printing operation from the information processing terminal device;

FIG. 4 shows an explanatory schematic diagram indicating an example of an active job list;

FIG. 5 shows an explanatory schematic diagram indicating a data structure of data stored in a storage of an output controlling server;

FIG. 6 shows a chart indicating data flows in regard to output instructions;

FIG. 7 shows a sequence schematic diagram of data flows in regard to output instructions;

FIG. 8 shows an explanatory schematic diagram indicating an example of an output operating screen when changing an output destination;

FIG. 9 shows a sequence schematic diagram of data flows in regard to output change instructions;

FIG. 10 shows a flowchart of an output destination change processing to be conducted by an output controlling server that receives an output destination change instruction;

FIG. 11 shows an explanatory schematic diagram indicating data structures of data stored in the storage before and after a job transferring operation, indicating a contrast between them;

FIG. 12 shows an explanatory schematic diagram indicating a time chart of a print processing flow from the time when a notification of print completion of the preceding job is received from an output apparatus to the time when an output controlling server transfers a next job to the output apparatus;

FIG. 13 shows an explanatory schematic diagram indicating a time chart of processing at the time when an output controlling server of the data outputting system of the second embodiment of the present invention controls a transfer commencing time;

FIG. 14 shows a schematic diagram indicating a configuration of an output controlling server according to the second embodiment of the present invention;

FIG. 15(a), FIG. 15(b), FIG. 15(c) and FIG. 15(d) show explanatory schematic diagrams indicating time charts of print processing flows in each of which a transfer commencing time and/or a temporal suspension of a transferring operation is/are corrected and controlled on the basis of a difference between a predicted developing time and a real developing time;

FIG. 16(a) and FIG. 16(b) explanatory schematic diagrams indicating time charts of correction controlling operations when a transfer commencing time of a predicted next job is preceding to a completion of transferring operation of a preceding job;

FIG. 17 shows a flowchart of a transferring control processing to be conducted by an output controlling server embodied in the present invention as the second embodiment; and

FIG. 18 shows a sequence chart of a data outputting system in regard to the second embodiment of the present invention, in which a plurality of jobs are processed.

### DETAILED DESCRIPTION OF THE PREFERRED EMBODIMENT

Referring to the drawings, various examples embodied in the present invention will be detailed in the following.

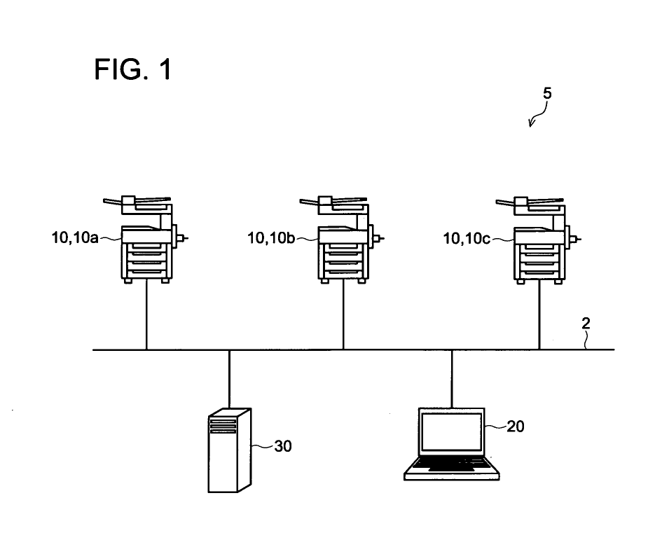

FIG. 1 shows an exemplified configuration of a data outputting system 5 embodied in the present invention. The data outputting system 5 is constituted by a plurality of output apparatuses 10, an information processing terminal device 20 and an output controlling server 30, which are coupled to each other through a network 2.

Each of the plurality of output apparatuses 10 (hereinafter, referred to as an output apparatus 10, for simplicity), such as a printer, a facsimile, a compound apparatus, etc., conducts an output operation (including a box storing operation, etc.) with respect to image data. In the example shown in FIG. 1, the output apparatus 10 is defined as a digital compound apparatus (in other words, a Multi-Function Peripheral, hereinafter, also referred to as a MFP) having a plurality of functions including a printer function, a scanner function, a facsimile function, etc. The information processing terminal device 20 includes a personal computer, etc., and is provided with a function for transmitting a job, such as a printing job, a facsimile transmission job, etc., and a function for instructing the implementation of the outputting operation. Further, the output controlling server 30 is provided with a communicating function, a storing function, etc. Although only a single unit of the information processing terminal device 20 is indicated in FIG. 1, a plurality of information processing terminal devices could be coupled to the network. Further, although a first output apparatus 10a, a second output apparatus 10b and a third output apparatuses 10c are exemplified as the output apparatuses 10 in FIG. 1, it is needless to say that an arbitrary number of output apparatuses 10 could be coupled to the network.

In the data outputting system 5, the output controlling server 30 receives the job transmitted from the information processing terminal device 20 and holds the job within the output controlling server 30 until the implementation of the job is enabled in the output apparatuses 10 designated as the output destination of the job concerned, and at the same time, conducts the controlling operations for synchronizing (controlling operations of the transfer timing, etc.) until the implementation of the job is enabled in the output apparatuses 10 designated as the output destination of the job. Further, during the time when holding the job concerned, the output controlling server 30 can receive an instruction for changing the output destination of the job, transmitted from the information processing terminal device 20.

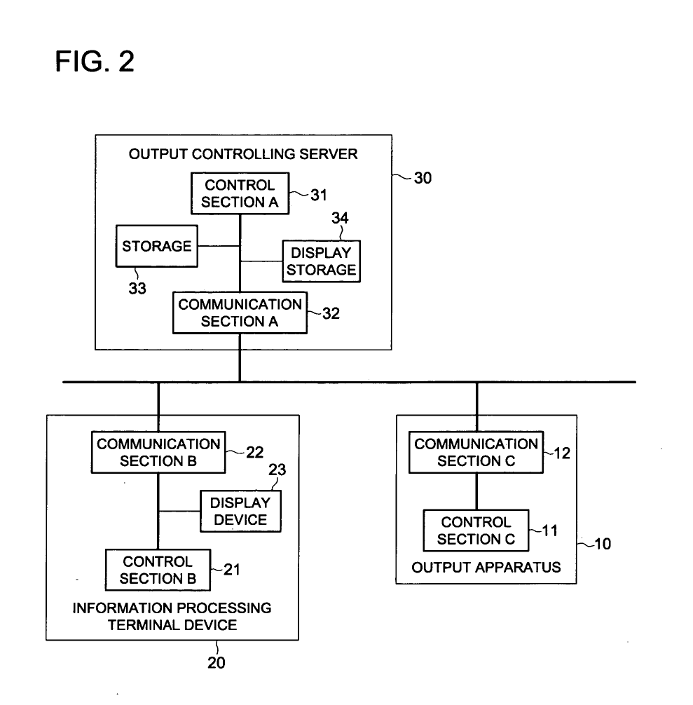

FIG. 2 shows a main functional configuration of the data outputting system 5. The output controlling server 30 is provided with a control section A31, a communication section A32, a storage 33, and a display storage 34. Further, the information processing terminal device 20 is provided with a control section B21, a communication section B22 and a display device 23. Still further, the output apparatus 10 is provided with a control section C11 and a communication section C12.

Incidentally, each of the control section A31, the control section B21 and the control section C11, provided in each apparatus, is constituted by a CPU (Central Processing Unit), a ROM (Read Only Memory), a RAM (Random Access Memory), etc. Further, the output apparatus 10 is provided with a printing section, a facsimile controlling section, a scanner section, a data storage section, etc.

The control section B21 of the information processing terminal device 20 transmits a job (including, for instance, output data, such as document data, image data, etc., and setting data, such as a job type of print, facsimile transmission, etc., setting information with respect to the output operation, etc.) and an output instruction, including the information for designating the output apparatus 10 of its output destination, to the output controlling server 30. The communication section A32 of the output controlling server 30 receives the job and the output instruction transmitted from the information processing terminal device 20, and the storage 33 stores the job based on the output instruction received by the communication section A32 in it, while correlating the job with the output destination information indicating the output apparatuses 10 of its output destination. The storage 33 is constituted by, for instance, a hard disc drive, etc., so as to store the data.

The control section A31 of the output controlling server 30 controls the output apparatuses 10 designated as the output destination of the job stored in the storage 33, so as to reserve the output operation of the job concerned. Since the job is held within the output controlling server side in a non-transferred state, it becomes possible to secure the output order at the output destination apparatus in the output controlling server side.

The control section C11 of the output apparatuses 10 receives the output reservation command sent from the output controlling server 30, and then, internally registers the reservation queue, etc. Further, when the implementation of the reserved output job is enabled, the communication section C12 requests the output controlling server 30 to transmit the job concerned.

The control section A31 of the output controlling server 30 conducts the transfer controlling operation in such a manner that, with respect to each of the jobs, output operations of which are already reserved and which are stored in the storage 33, the control section A31 determines a time when the implementation of the concerned job is enabled in the output apparatuses 10 of its output destination, so as to transfer the job stored in the storage 33 to the designated output apparatus corresponding to the time determined in the above. For instance, the control section A31 determines the time for enabling the implementation of the job, based on the notification of the job information request, a prediction of the processing time in the output apparatuses 10, estimated in the output controlling server 30 side.

According to the above, it becomes possible for the output apparatus to commence the next job, just after the preceding job is completed, without generating any time lag between the jobs. The transfer controlling method for completing the transferring operation at the abovementioned timing can be arbitrarily established, and for instance, controlling items, such as a transferring velocity, a transfer commencing timing, a temporarily suspension of the transfer operation, etc., could be employed for achieving the transfer controlling operation mentioned in the above.

The control section B21 of the information processing terminal device 20 transmits an instruction for changing the output destination of the job stored in the storage 33 of the output controlling server 30. The control section A31 of the output controlling server 30 receives the instruction for changing the output destination of the job from the information processing terminal device 20, and operates-the internal data, so as to store the job designated by the instruction for changing the output destination of the job, while correlating the job with the output destination information indicating the output apparatuses changed as a revised output destination. This procedure makes it easy to change the output destination.

The control section A31 of the output controlling server 30 conducts controlling operations for displaying the operating screen onto the information processing terminal device 20. The display storage 34 stores layout information (like map information) in regard to the installation sites of the output apparatuses 10. The controlling operations, mentioned in the above, includes a generating operation of the operating screen to be displayed on the information processing terminal device 20, corresponding to the layout information stored in the display storage 34 and the storing status of the job in the storage 33.

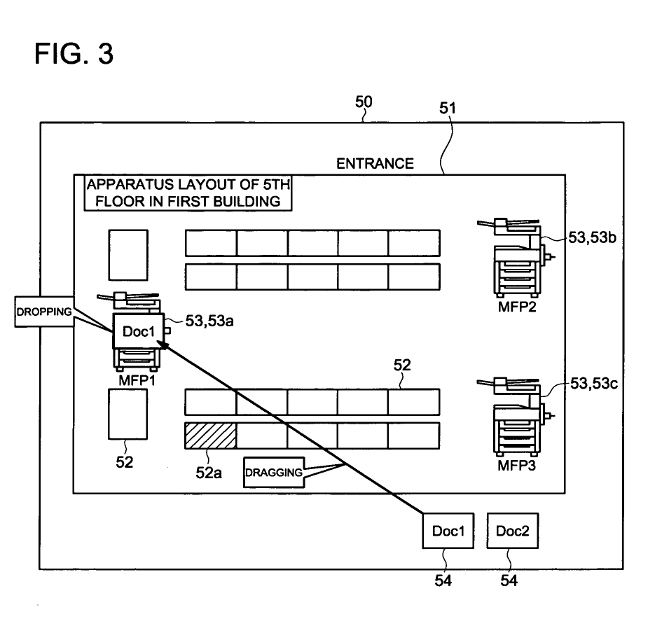

FIG. 3 shows an example of an output operating screen 50 to be displayed on the display device 23 of the information processing terminal device 20 when instructing the printing operation from the information processing terminal device 20. Further, the output operating screen 50 is a Web page provided from the output controlling server 30 and displayed by utilizing the browse function of the information processing terminal device 20.

A layout screen 51 for indicating the arrangement of the output apparatuses 10a, 10b, 10c is displayed on the output operating screen 50. In the layout screen 51, the objects, such as a desk 52, etc., are indicated according to the real arrangement of them, and icons 53 (hereinafter also referred to as apparatus icons 53), each of which corresponds to each of the output apparatuses 10, are displayed at positions corresponding to the places at which the output apparatuses 10a, 10b, 10c are really installed, respectively.

ID information (herein, machine numbers, such as MFP1, MFP2, etc.), corresponding to each of the output apparatuses 10a, 10b, 10c, are attached to corresponding one of the apparatus icons 53. In the example shown in FIG. 3, the first output apparatus 10a, the second output apparatus 10b and the third output apparatus 10c, shown in FIG. 1, correspond to an apparatus icon 53a, an apparatus icon 53b and an apparatus icon 53c, respectively.

Further, data icons 54, each of which corresponds to each of the output-enabled data files, are indicated on the output operating screen 50. The file name of the data file (such as Docl, etc., as shown in FIG. 3) are attached to each of the data icons 54. Further, the position of the information processing terminal device 20, which currently displays the output operating screen 50, is also clearly indicated (in the example shown in FIG. 3, desk 52a indicated by diagonal lines).

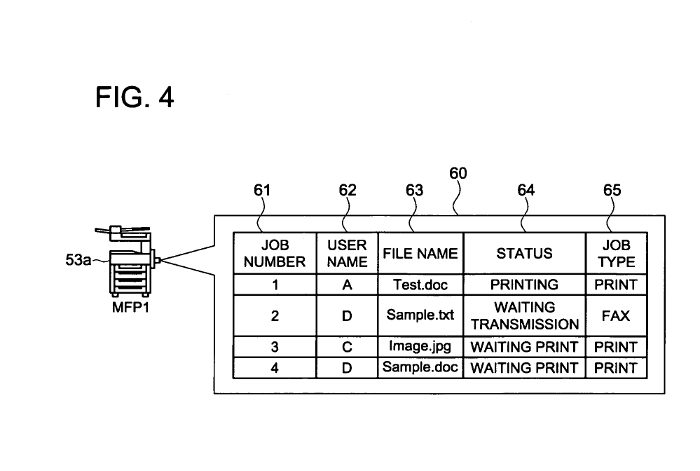

As shown in FIG. 4, when the user clicks the apparatus icons 53 indicated on the layout screen 51, or drags any one of the data icons 54 onto the apparatus icons 53, an active job list 60, corresponding to the apparatus icons 53 concerned, emerges in a popup mode. In the active job list 60, the information in regard to the jobs, which are introduced by designating the output apparatuses 10 and still in a standby state without completing the output operation, are indicated as a synoptic table, in which a job number 61, a user name 62, a status 64 (such as a printing status, a standby status, etc.), a job type 65 (such as a printing job, a facsimile transmission job, etc.), etc. are indicated.

In the information processing terminal device 20, dragging and dropping the data icons 54 onto the apparatus icons 53 by using a mouse serving as a pointing device (not shown in the drawings), the printing instruction (outputting instruction), for conducting a printing operation based on the data file corresponding to the data icons 54 concerned, by employing the output apparatuses 10 corresponding to the apparatus icons 53 thereof, is transmitted to the output controlling server 30 from the information processing terminal device 20. From the user's point of view, the user would feel as if the concerned job were really transmitted to the output apparatus by the dragging and dropping operation mentioned in the above. According to the above feature, it becomes possible to transmit the output instruction or the output destination change instruction while confirming the arrangement of each of the output apparatuses 10, resulting in improvement of maneuverability and convenience-ability.

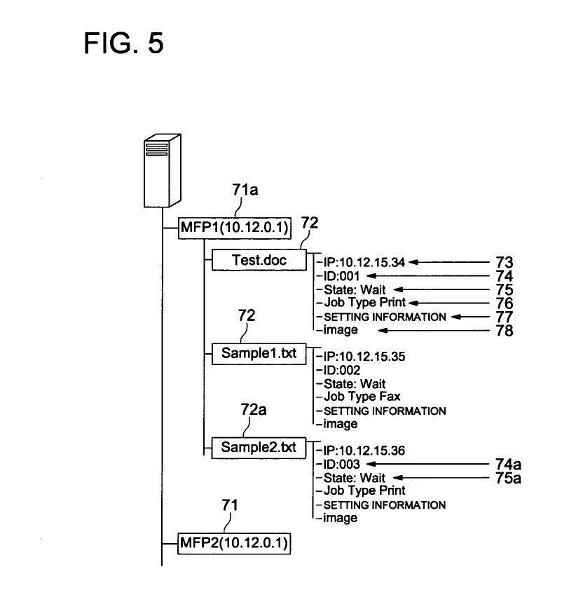

FIG. 5 shows a data structure of the data stored in the storage 33 of the output controlling server 30. In the storage 33, an output destination folder 71, serving as a folder corresponding to each of the output apparatuses 10 coupled to the data outputting system 5, is generated, and further, a job folder 72 is created in the output destination folder 71 for every job, which designates the output apparatus 10, corresponding to the output destination folder 71 concerned, as the output destination. The output destination folder 71 is generated by attaching the name of the output apparatus 10 (such as MFP1, MFP2, etc.) or IP (Internet Protocol) address as the folder name. Regarding the output destination folder 71, for instance, when a certain output apparatus 10 is initially coupled to the data outputting system 5, the output destination folder 71, corresponding to the output apparatus 10 concerned, is automatically generated.

In each of the job folders 72, the job, including the setting data, output data, etc. of the job concerned, are stored. In the example shown in FIG. 5, an IP address 73 of the information processing terminal device 20 being a sender of the job, a job ID 74 notified from the output apparatus 10 at the reservation time, status information 75 of the job concerned, a job type 76, setting information 77, output data 78 including the image, etc. are stored in the job folder 72.

Next, internal controlling operations, to be conducted when the output instruction (printing instruction) is transmitted to the output apparatus 10 from the information processing terminal device 20, will be detailed in the following.

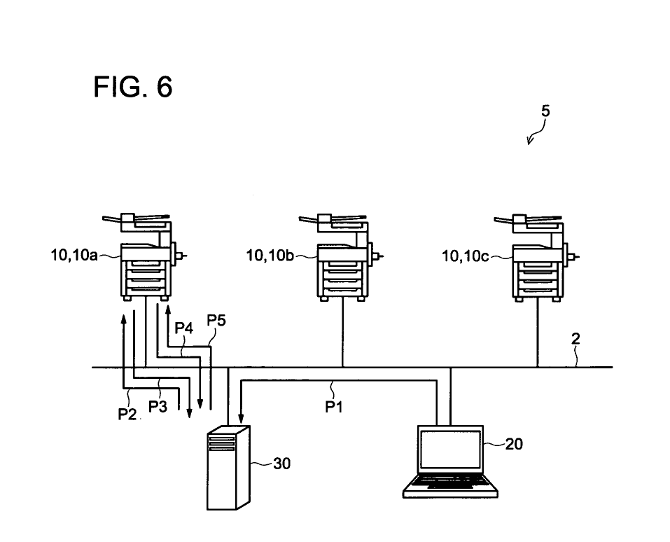

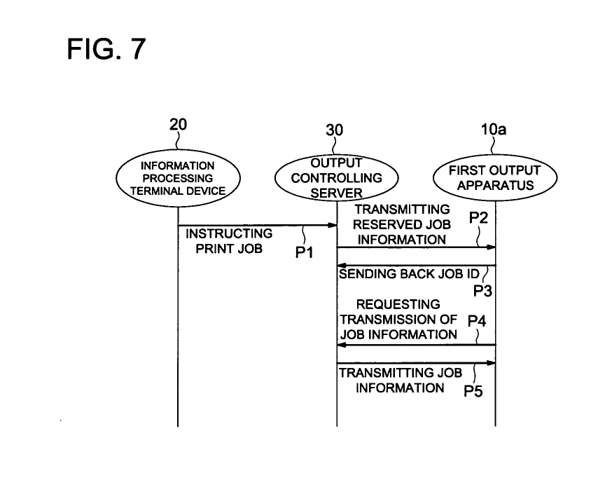

FIG. 6 shows a chart indicating data flows in the internal controlling operations mentioned above, plotting them on the system configuration, while FIG. 7 shows a sequence schematic diagram of the data flows. Operations P1-P4 indicated in FIG. 6 correspond to those indicated in FIG. 7. Incidentally, in FIGS. 6 and 7, the first output apparatus 10a is established as the output destination and the file named “Sample2.txt” is the output data.

At first, the output instruction generated according to the operating method shown in FIG. 3 and the job concerned are transmitted to the output controlling server 30 from the information processing terminal device 20 (operation P1). The output controlling server 30 stores the job, including the setting data and the output data received from the information processing terminal device 20, into the storage 33. For instance, in the data structure shown in FIG. 5, the new job folder 72a is created in the output destination folder 71a corresponding to the first output apparatus 10a, which is designated as the output destination, so as to store the setting data and the output data, in regard to the output instruction currently received, into the new job folder 72a newly created.

Further, the output controlling server 30 acquires the job type and the IP address of the information processing terminal device 20 serving as the sender, from the data received from the information processing terminal device 20, to conduct output reserving operation by transmitting the reserved job information (namely, information indicating the IP address, the job type, etc.) to the first output apparatus 10a, which is designated as the output destination (operation P2). Receiving the reserved job information, the first output apparatus 10a registers the job as the active job of the functions (such as a printing, a facsimile transmission, a box storing, etc.) corresponding to the job type thereof.

The information processing terminal device 20 attaches a job ID to the job concerned at the registering time of the job, and returns the job ID to the output controlling server 30 (operation P3). Receiving the job ID, the output controlling server 30 registers the received job ID into the job folder 72 of the job for which the job reservation information was issued. In the example shown in FIG. 5, the job ID “003” (indicated by numeral 74a in the FIG. 5) is registered into the job folder 72a corresponding to the job named “Sample2.txt”. Further, “Wait” (indicated by numeral 75a in the FIG. 5), indicating a waiting status of the output operation, is registered as the status information of the job.

At the time when the implementation of any one of the jobs currently registered as the active jobs is newly enabled, the first output apparatus 10a transmits a request for sending the job information, including the job ID of the job concerned, to the output controlling server 30. According to this action, the output controlling server 30 is requested to transmit the setting data and the output data of the concerned job to the first output apparatus 10a (operation P4). For instance, when the preceding job is completed, the implementation of another job, whose reservation order is next to the preceding job, is newly enabled, and then, the request for sending the job information, serving as a transmission request of data in regard to the job concerned, is transmitted to the output controlling server 30.

Receiving the request for sending the job information, sent from the first output apparatus 10a, the output controlling server 30 retrieves the job folder 72, in which the job ID of the job concerned is registered, from the output destination folder 71a corresponding to the first output apparatus 10a, in order to transmit the job including the setting data and the output data stored in the job folder 72 thereof to the first output apparatus 10a (operation P5). For instance, when the output controlling server 30 receives the request for sending the job information including the job ID “003” from the first output apparatus 10a during the state of “Wait” shown in FIG. 5, the output controlling server 30 transfers the setting data and the output data stored in the job folder 72a to the first output apparatus 10a.

Receiving the setting data and the output data transferred from the output controlling server 30, the output apparatuses 10 implements the job, such as the printing operation, etc., according to the received data.

Next, the operation for changing the output destination of the job, which is already transmitted from the information processing terminal device 20 to the output controlling server 30, to another output apparatus, will be detailed in the following.

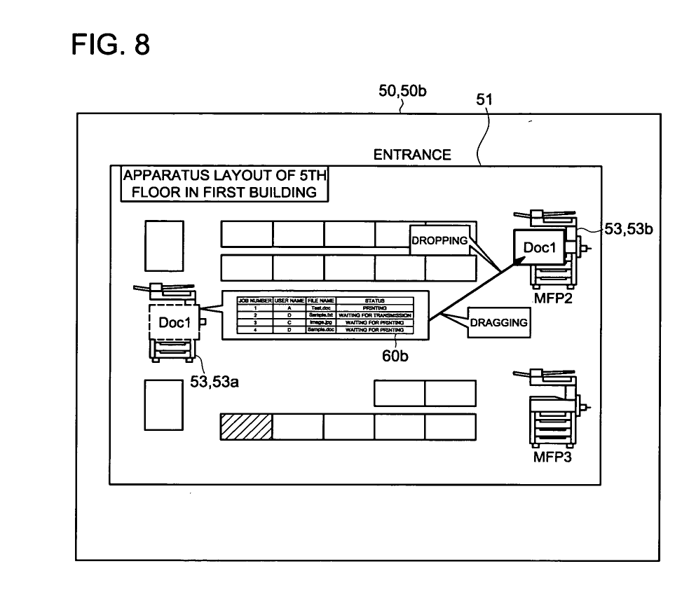

For instance, when a lot of preceding jobs still exist in the output destination designated by the user, or when the jobs have not implemented due to a certain malfunction caused by a paper jamming, a paper shortage, etc., sometimes, the implementation of the job, for which the output instruction was already transmitted, should be waited in the standby state for a long time. To cope with such the case, the data outputting system 5, embodied in the present invention, is so constituted that the output destination is changeable according to the dragging and dropping operation indicated in the output operating screen 50b shown in FIG. 8.

Concretely speaking, clicking the apparatus icon 53 indicated on the layout screen 51 to display the active job list 60b of the output apparatus 10 concerned, and dragging and dropping the objective job selected form the active job list 60b onto another apparatus icon 53, the output destination of the job is changed to another output apparatus 10 corresponding to the other apparatus icon 53 dropped, and at the same time, the reservation of the job in the original output apparatus 10 is cancelled. In the example shown in FIG. 7, by dragging and dropping the data icon 74a onto the apparatus icons 53b, the job “Docl” is moved from the first output apparatus 10a to the second output apparatus 10b.

Next, the internal controlling operation, for moving the job from the first output apparatus 10a to the second output apparatus 10b, will be detailed in the following.

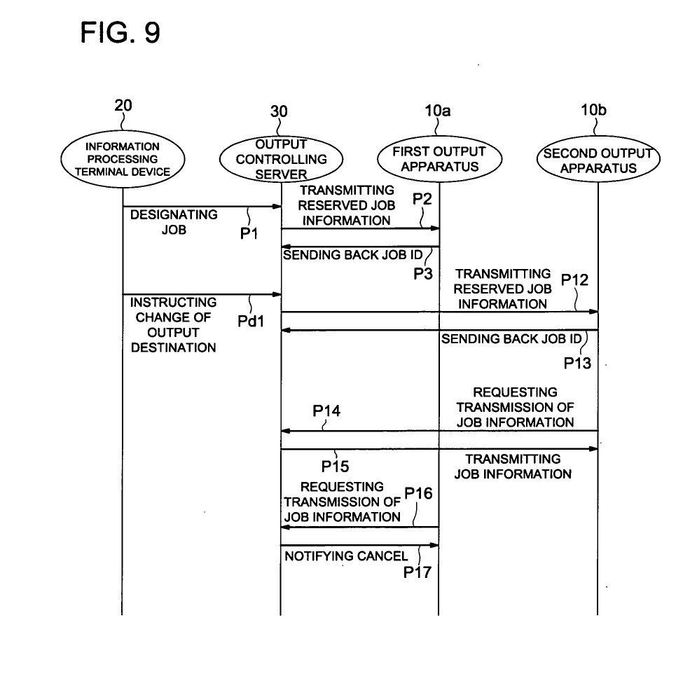

FIG. 9 shows a sequence schematic diagram of the data flows when the output destination of the job is changed to the second output apparatus 10b after the output instruction, designating the first output apparatus 10a as the output destination, is transmitted from the information processing terminal device 20. Operations P1-P3 indicated in FIG. 9 are the same as those indicated in FIG. 7, and accordingly, the explanations of them are omitted.

When the operation for changing the output destination is conducted according to the dragging and dropping operation shown in FIG. 8, the output destination changing instruction, which indicates contents of the change, is transmitted from the information processing terminal device 20 to the output controlling server 30 (operation P11). The output destination changing instruction includes the job ID, the IP addresses before and after the change operation, etc.

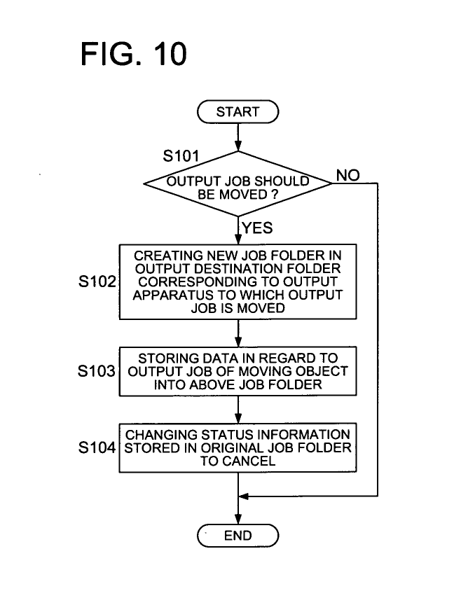

Receiving the output destination changing instruction, the output controlling server 30 implements the output destination change processing shown in FIG. 10. Concretely speaking, the flowchart of the output destination change processing shown in FIG. 10 includes the operational steps of: determining a presence or absence of the job transfer, based on the result of determining whether or not the output apparatuses are different from each other after and before receiving the output destination changing instruction (Step S101); finalizing the processing as it is, when absence of the job transfer is determined in Step S101 (END); creating a new job folder 72 for the job concerned in the output destination folder 71 corresponding to an output apparatuses 10 changed (serving as the transfer destination), when presence of the job transfer is determined in Step S101 (Step S101, Y); duplicating various kinds of information in respect to the job being the object for transferring to the job folder 72 (Step S103); changing the job status information registered in the job folder 72 of the sender to “Cancelled” (Step S104); and finalizing the processing (END).

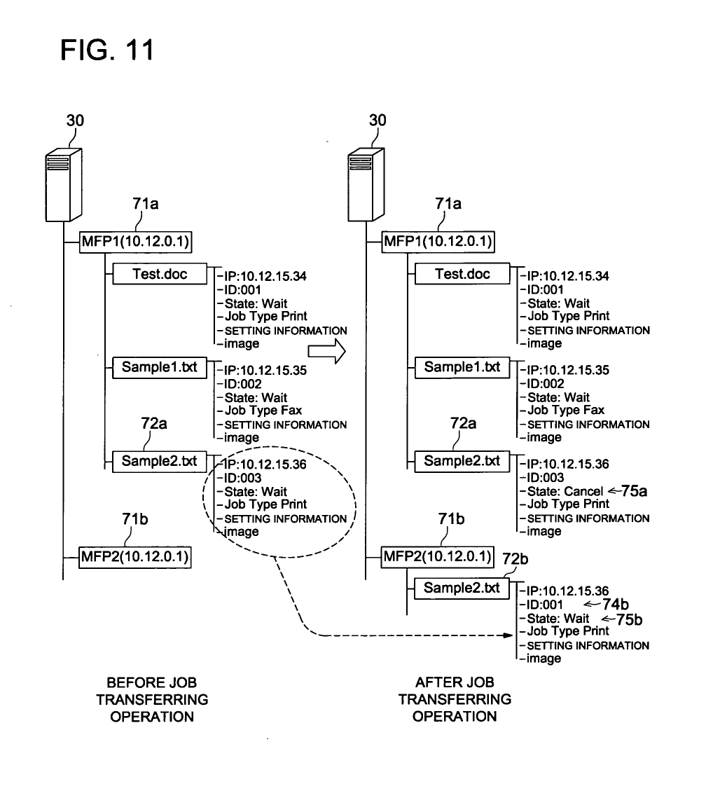

FIG. 11 shows data structures of the data stored in the storage 33 before and after the job transferring operation, indicating the contrast between them. In FIG. 11, the case in which the output destination of the job “Sample2.txt” is changed from the first output apparatus 10a to the second output apparatus 10b is exemplified. After the job transferring operation is completed, the job folder 72b corresponding to the job “Sample2.txt” is newly created in the output destination folder 71b corresponding to the second output apparatus 10b, and the setting data and the output data registered in the job folder 72a before the job transferring operation are duplicated therein. In the job folder 72a before the job transferring operation, the status information 75 of the job is changed from “Wait” to “Cancel”.

After that, as well as the case of the output instruction, the reservation job information (namely, information indicating the IP address and the job type) are transmitted to the second output apparatus 10b so as to reserve the output operation of the job concerned (operation P12 shown in FIG. 9), and the job ID returned from the second output apparatus 10b is registered in the job folder 72 concerned (operation P13). As shown in FIG. 11, in the job folder 72b after the job-transferring operation, the job ID “001” (74b) is registered and the status information of the job is changed to “Wait” (75b).

Receiving the job information transmitting request including the job ID “001” from the second output apparatus 10b (operation P14 shown in FIG. 9), the output controlling server 30 transfers the setting data and the output data, stored in the job folder 72b concerned, to the second output apparatus 10b (operation P15).

On the other hand, receiving the job information transmitting request including the job ID “003” from the first output apparatus 10a being the output destination before the changing operation (operation P16), the output controlling server 30 erases and deletes various kinds of information (including the setting data and the output data) still stored in the job folder 72a (refer to “AFTER TRANSFER” shown in FIG. 11) and the job folder 72a itself from the storage 33, since the status information of the job is set to “Cancel” (75a) in the job folder 72a concerned. Further, the output controlling server 30 transmits the notification of the job cancel to the first output apparatus 10a (operation P17 shown in FIG. 9).

Receiving the notification of the job cancel, the first output apparatus 10a implements the cancel processing of the job corresponding to the job information transmitting request previously transmitted, and shifts to the processing of the next job. For instance, the cancel processing to be performed in the first output apparatus 10a includes the operation for changing the history of the active job list to the cancel status, etc.

As mentioned in the foregoing, since the data in regard to the job (including the setting data and the output data) are stored in the storage 33 of the output controlling server 30 until the implementation of the data is enabled in the output apparatus 10 designated as the output destination, it is possible for the user to change the output destination by activating the internal data processing of the output controlling server 30, as far as the data is stored within the output controlling server 30. Accordingly, it becomes unnecessary for the user to conduct such a complicated operation that, in spite of introducing the job to a certain output apparatus, the job should be once deleted from the output apparatus, and then, newly introduced into another output apparatus after the apparatus changing operation is completed, while it becomes possible for the user to easily change the output destination by simply conducting dragging and dropping operations. Accordingly, even if the output apparatus falls into such a situation that the previously introduced jobs cannot be completed due to the malfunction caused by the paper jamming or the paper shortage, etc., the job can be easily moved to another output apparatus. In addition, since the output destination can be easily confirmed on the layout screen, it becomes possible for the user to easily transfer the job to the objective output apparatus. Therefore, it becomes possible to provide an outputting environment having higher maneuverability and convenience-ability than ever.

Next, the second embodiment will be detailed in the following.

Although the time when the implementation of the job in the output apparatus 10 is enabled, is determined on the basis of the job information transmitting request sent from the output apparatus 10 in the first embodiment, the output controlling server 30 predicts the time when the implementation of the next job in the output apparatus 10 is enabled in the second embodiment, so that the output controlling server 30 controls the data transferring operation from the output controlling server 30 to the output apparatus 10, based on the prediction mentioned in the above.

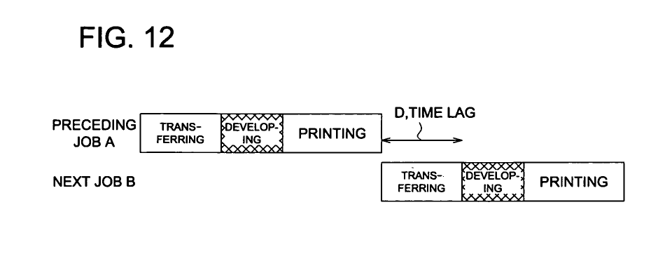

FIG. 12 shows a time chart of the print processing flow from the time when the notification of the print completion of the preceding job is received from the output apparatus 10 to the time when the output controlling server 30 transfers the next job to the output apparatus 10. In the case that the transferring operation of a next job B is commenced after the completion of the printing operation for a preceding job A is confirmed, a time lag D emerges between the completion of the preceding job A and the commencement of the printing operation for the next job B. This results in a deterioration of the printing efficiency.

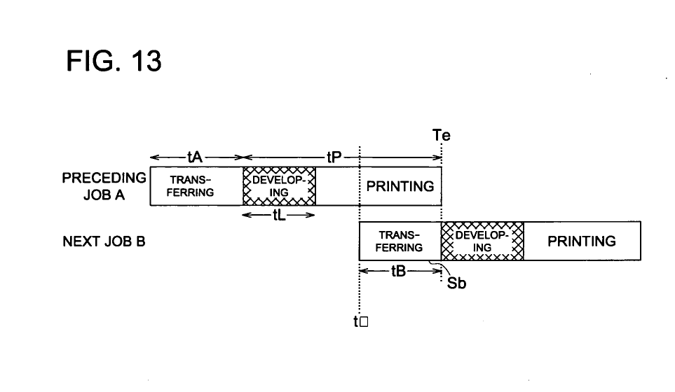

To solve the abovementioned problem, in the data outputting system 5 according to the second embodiment of the present invention, as shown in FIG. 13, the output controlling server 30 controls a commencing time of a data transfer Sb, so that the data transfer Sb of the next job B is completed at the time Te just when the printing operation for the preceding job A is finalized in the output apparatus 10.

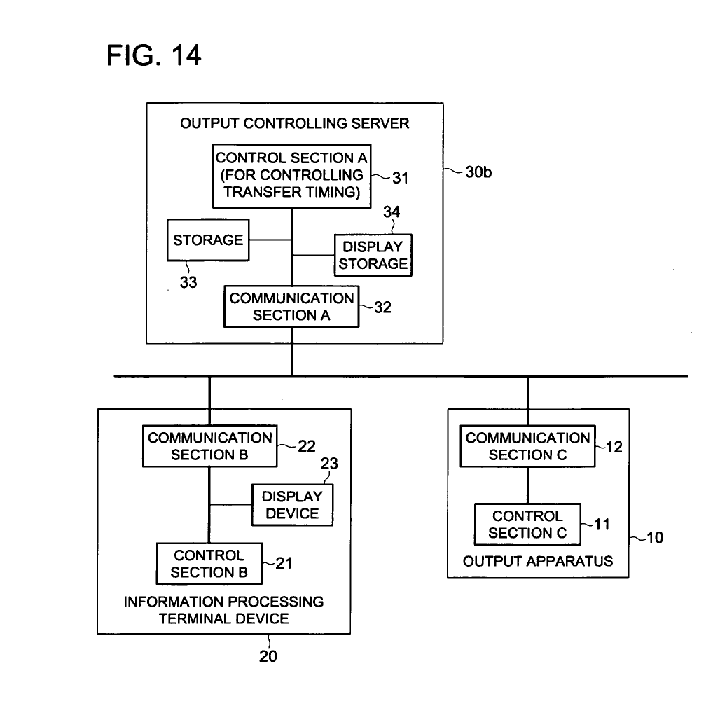

FIG. 14 shows a configuration of an output controlling server 30b according to the second embodiment of the present invention. The same reference numbers are attached to the blocks same as those of the output controlling server 30 shown in the first embodiment of the present invention. In the output controlling server 30b according to the second embodiment of the present invention, the control section A31 controls transfer timings.

The controlling operation of the transfer timing, to be conducted by the control section A31, includes: a first calculating step for calculating a predicted completion time, defined as a predicted value of the time when the output processing (print processing) for the first job transferred to the output apparatus 10 is completed in the apparatus of the output destination thereof; a second calculating step for calculating a predicted transfer time, defined as a predicted value of the time interval necessary for transferring the second job, to be transferred next to the first job, from the output controlling server 30 to the output apparatus 10; and establishing a time, which precedes to the predicted completion time calculated in the first calculating step, by the predicted transfer time calculated in the second calculating step, as the transfer commencing time. In the event of establishing the transfer commencing time, the control section A31 also corrects the deviation of the predicted value by correcting the transfer commencing time calculated in the above or by temporarily suspending the transferring operation.

Referring to the example shown in FIG. 13, the operations for controlling the transfer timing, to be conducted in the control section A31, will be detailed in the following. When receiving the file of the preceding job A (including printing data, etc.) from the information processing terminal device 20, the output controlling server 30b stores a size fa of the file and the print settings as the fundamental data for calculation. Since a transferring rate r between the output controlling server 30b and the output apparatus 10 is measured at constant intervals in the controlling operation of the transfer timing, the transfer time tA of the preceding job A can be derived from the following equation in the first calculating step.

tA=fa/r

Further, a print processing time interval tP, in regard to the output apparatus 10 concerned, can be derived from the print settings of the file and the efficiency of the output apparatus 10 conducting the print operation for the file concerned.

Incidentally, the print processing time interval tP includes both the data developing time interval and the printing time interval of the image represented by the data. A predicted value (a first predicted time tL) is found as an average processing time for developing, from the size fa of the file and the ability (data developing efficiency) of the CPU equipped in the output apparatus 10. Further, the printing time interval can be calculated from the developed data, the printing efficiency (printing velocity) of the output apparatus 10 and the print settings (both sides or one side, etc.). In the first calculating step, the predicted completion time, being a predicted value of the time when the print processing for the preceding job A is completed in the output apparatus 10, is found from the current time and the calculated time of (tA+tP).

Further, when the next job B is waiting in a standby state, a transfer time tB of the next job B is found in the second calculating step. As well as the calculation of the transfer time tA of the preceding job A, the transfer time tB of the next job B can be derived from the following equation.

tB=fb/r

where fb: file size of next job B.

In the event of establishing the transfer commencing time, a transfer commencing time tC of the next job B can be calculated by subtracting the transfer time tB of the next job B, calculated in the second calculating step, from the predicted completion time (tA+tP) of the preceding job A, calculated in the first calculating step. By commencing the transferring operation of the next job B at the time when the transfer commencing time tC, calculated through the abovementioned process, has come, the transferring operation of the next job B can be completed at the time Te just after the printing operation for the preceding job A is finalized in the output apparatus 10, and it becomes possible to commence the print processing for the next job B without generating any time lag in the output apparatus 10.

Further, since the transferring operation is commenced at the timing as mentioned above, it is possible to hold the next job B within the site of the output controlling server 30b for the longest time interval as far as no time lag is generated, and therefore, it becomes easy to cope with the request of changing the output destination as shown in the first embodiment of the present invention.

Incidentally, due to the restriction that the developing operation for the next job cannot be commenced before the print operation of the preceding job is finalized, under the condition that the completion of the transferring operation for the next job is disabled before the print processing for the preceding job is finalized, the transfer commencing time tC found in the establishment of the transfer commencing time, is the fastest timing for commencing the transferring operation.

Next, the correcting operation, to be conducted in the establishment of the transfer commencing time, will be detailed in the following.

As described in the foregoing, since the average value is employed for finding the developing time of the job, the transfer commencing time tC is not necessary correctly (or precisely) found. Specifically, when the developing time of the preceding job A has become longer than the predicted value, it is necessary to take a certain kind of countermeasure, since such the situation contradicts the abovementioned condition that the completion of the transferring operation for the next job is disabled before the print processing for the preceding job is finalized.

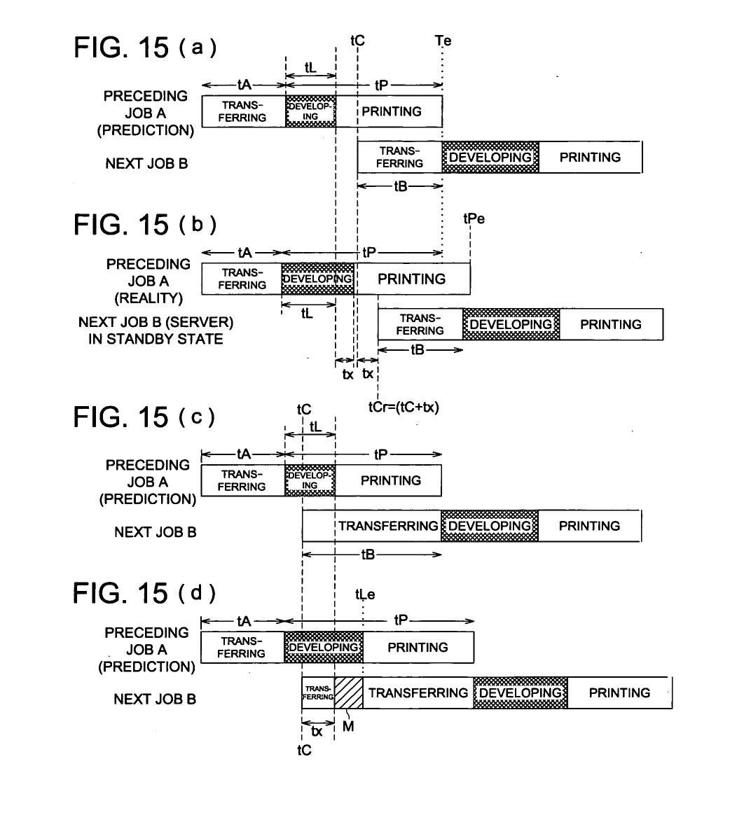

FIG. 15(a), FIG. 15(b), FIG. 15(c) and FIG. 15(d) show time charts of the print processing flows in each of which the transfer commencing time and/or the temporal suspension of the transferring operation is/are corrected and controlled on the basis of the difference between the predicted developing time and the real developing time. FIG. 15(a) shows a predicted transfer status, and FIG. 15(b) shows a real transfer status in which the real developing time of the preceding job A is longer than the predicted developing time (tL) by a time interval tx. Despite that the developing time is extended by the time interval tx, commencing the transferring operation of the next job B at the transfer commencing time tC initially found as shown in FIG. 15(a), the transferring operation of the next job B is completed before the printing operation for the preceding job A is finalized (at time tPe).

To solve the above problem, when the developing operation of the preceding job A is really completed, the output apparatus 10 transmits a developing operation completion notification to the output controlling server 30b, and if the developing operation completion notification has not come to the output controlling-server 30b even at the time when the predicted developing time (tL) has elapsed, the output controlling server 30b conducts a correcting operation corresponding to the differences thereof.

Concretely speaking, when the developing operation completion notification has not arrived from the output apparatus 10 even at the time when the predicted developing time (tL) has elapsed, and the transferring operation of the next job B has not commenced at this time, the transfer commencing time tC initially established is once made to be ineffective. Then, at the time when the developing operation completion notification arrives, the output controlling server 30b conduct a correcting operation, so as to delay the transfer commencing time tC, initially established, by a time difference between the real developing time and the predicted developing time (tL), and commences the transferring operation of next job B at this corrected transfer commencing time tCr.

On the other hand, as shown in FIG. 15(c), when the developing operation completion notification has not arrived from the output apparatus 10 even at the time when the predicted developing time (tL) has elapsed, and the transfer commencing time tC has passed, and the transferring operation of next job B has been already commenced, the transferring operation from the output controlling server 30b to the output apparatus 10 is instantaneously suspended just after the predicted developing time (tL) has elapsed (indicated by a diagonal line area M shown in FIG. 15(d)). Then, at the time when the developing operation completion notification arrives from the output apparatus 10, the transferring operation of the next job B, temporarily suspended, is resumed.

By correcting the transfer commencing time tC as described in the above, since the transferring operation of next job B is completed at the time when the print processing of the preceding job A is really finalized, it becomes possible to prevent an occurrence of such an erroneous operation that the transferring operation of next job B is completed before the print processing of the preceding job A is really finalized, and therefore, it becomes possible to commence the print processing of the next job B just after the finalization of the preceding job A without generating any time lag.

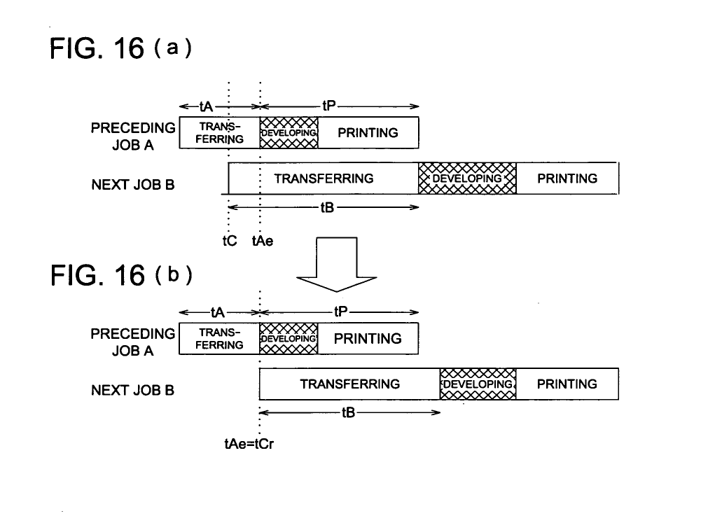

Next, referring to FIG. 16(a) and FIG. 16(b), the correcting operation of the transferring operation will be detailed in the following, with respect to such a case that the transfer commencing time tC of the next job B, initially predicted, is preceding to the transfer completion time tAe of the preceding job A, namely, since the transfer time of the next job B is too long, the transferring operation of the next job B should be commenced before the transfer time of the preceding job A is completed, in order to commence the print operation of the next job B at the time just after the finalization of the preceding job A.

In this case, as shown in FIG. 16(a), the transferring operations of the preceding job A and the next job B overlap with each other. Since it is impossible for the output apparatus 10 to receive and process both the preceding job A and the next job B at the same time in a normal situation, the output apparatus 10 changes the transfer commencing time tC, initially predicted, to a new one shown in FIG. 16(b). Namely, the output apparatus 10 adjusts the transfer commencing time of next job B so that the transfer completion time tAe is equal to the transfer commencing time tCr of the next job B. According to the abovementioned correction, although a some amount of time lag would be introduced between the print finalization of the preceding job A and the print processing commencement of the next job B, it becomes possible to minimize the time lag between the different printing operations, under the environment where the simultaneous transferring operation of a plurality of jobs are not allowed.

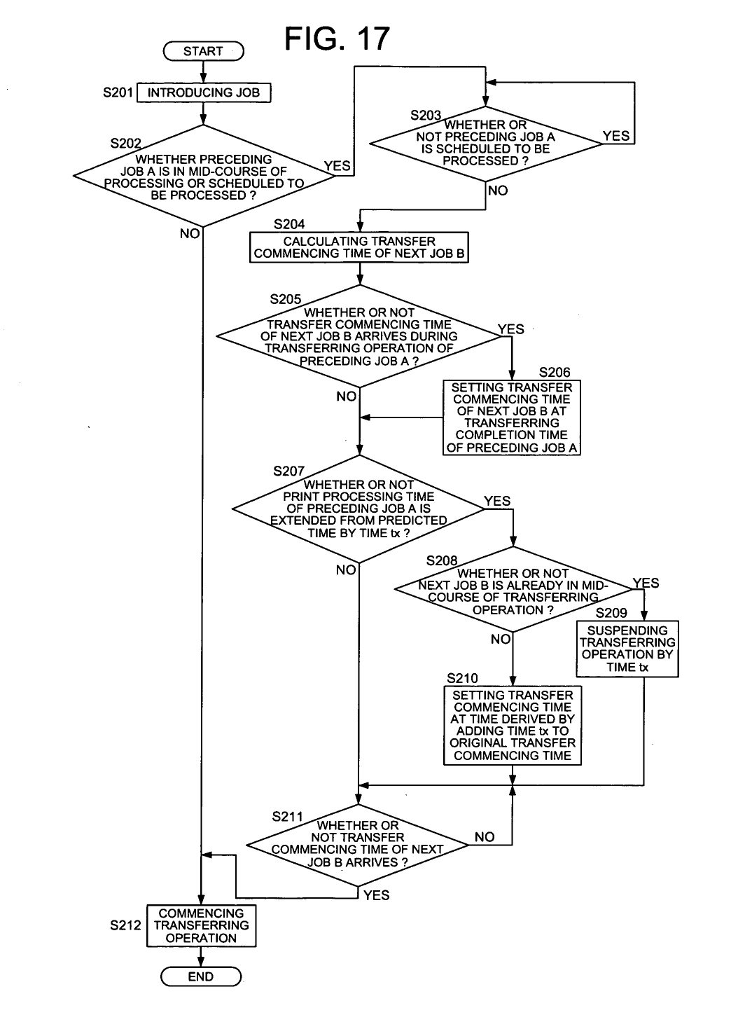

FIG. 17 shows a flowchart of the transferring control processing, mentioned in the above, to be conducted by the output controlling server 30b. The flowchart of the transferring control processing to be conducted by the output controlling server 30b includes the operational steps of: introducing the next job B as a new job (Step S201); determining whether or not, the preceding job A is in a mid-course of the processing (transferring operation) or is scheduled to be processed (Step S202); instantaneously commencing the transferring operation of the next job B (Step S212) when the preceding job A is neither in a mid-course of the processing nor is scheduled to be processed (Step S201, No), and then, finalizing the processing (END); waiting the time when the preceding job A enters in the processing (Step S203, Yes), when the preceding job A is either in a mid-course of the processing or scheduled to be processed (Step S202, Yes); calculating the transfer commencing time of the next job B as shown in FIG. 13 (Step S204), when the preceding job A is in a mid-course of the processing or enters into the processing from the processing scheduled status (Step S203, No); correcting the transfer commencing time of the next job B so as to make the transfer commencing time of the next job B equal to the transferring completion time of the preceding job A (Step S206), when the transfer commencing time of the next job B arrives during the transferring operation of the preceding job A (Step S205, Yes, as indicated in FIG. 16(a) and FIG. 16(b)); temporarily suspending the transferring operation of the next job B by time tx (Step S209), when the print processing time (developing processing time) of the preceding job A is extended by time tx compared to the predicted time interval (Step S207, Yes) and the next job B is in a mid-course of its transferring operation (Step S208, Yes, as indicated in FIG. 15(c) and FIG. 15(d)); correcting the transfer commencing time tC, initially established, to a new transfer commencing time derived by adding the time tx to the transfer commencing time tC (Step S210), when the transferring operation of the next job B is not yet commenced (Step S208, No, as indicated in FIG. 15(b)); waiting the arrival of the transfer commencing time established or corrected in the steps as mentioned in the above (Step S211, No), except the case that the transferring operation of the next job B is already commenced; and commencing the transferring operation of the next job B (Step S212), when the transfer commencing time arrives (Step S211, Yes), and then, finalizing the processing (END).

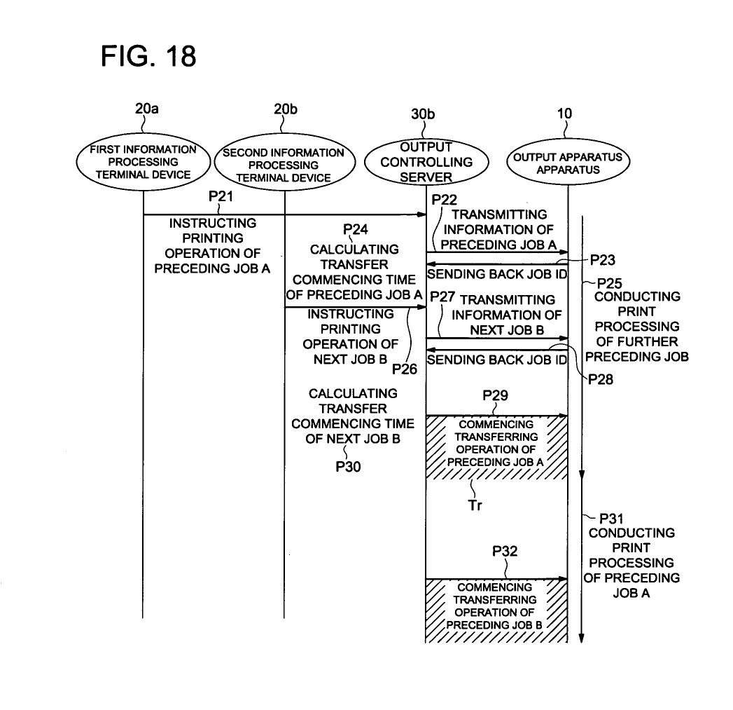

FIG. 18 shows a sequence chart of the data outputting system 5 in regard to the second embodiment of the present invention, in which a plurality of jobs are processed. When the first information processing terminal device 20a transmits a print instruction (output instruction) of the preceding job A to the output controlling server 30b (P21), the output controlling server 30b stores the setting data and the output data received from the first information processing terminal device 20a into the storage 33. Further, the output controlling server 30b transmits the reservation job information to the output apparatus 10 designated as the output destination of the preceding job A, in order to reserve the output operation of the preceding job A (P22).

Based on the reservation job information received from the output controlling server 30b, the output apparatus 10 registers the preceding job A as the active job, and sends the job ID, allotted to the job concerned, back to the output controlling server 30b (P23).

If a job, having a job ID further preceding to that of the preceding job A and waiting in a standby state, does not exist, the output controlling server 30b regards the preceding job A as the next job to be implemented, and finds the transfer commencing time of the preceding job A from the print processing time of the further preceding job, the job information of the preceding job A (including the data amount of the output data, etc.), the transferring rate, efficiency of the output apparatus 10, etc. (P24). Then, the output apparatus 10 commences the printing operation of the job further preceding to the preceding job A (P25).

After that, when the second information processing terminal device 20b transmits the print instruction (output instruction) of the next job B, in which the output destination is the same as that of the preceding job A, to the output controlling server 30b (P26), the output controlling server 30b stores the setting data and the output data of the next job B concerned into the storage 33. Further, the output controlling server 30b transmits the reservation job information to the output apparatus 10 designated as the output destination of the next job B, in order to reserve the output operation of the next job B (P27).

Based on the reservation job information received from the output controlling server 30b, the output apparatus 10 registers the next job B as the active job, and sends the job ID, allotted to the job concerned, back to the output controlling server 30b (P28).

When the transfer commencing time of the preceding job A arrives, the output controlling server 30b commences the operation for transferring the data of preceding job A to the output apparatus 10 (P29), and at the same time, calculates the transfer commencing time of the next job B (P30).

In the output apparatus 10, the transferring operation of the preceding job A is completed at substantially the same time when the print processing of the further preceding job is finalized, and therefore, the print processing of the preceding job A is implemented without generating any time lag (P31). A part Tr depicted by the diagonal lines indicates a transferring time period of the preceding job A.

After that, when the transfer commencing time of the next job B arrives in a mid-course of the printing operation of the preceding job A, the transferring operation of the next job B is commenced (P32). Incidentally, as mentioned in the foregoing, the transfer commencing time is corrected as needed.

As mentioned in the foregoing, since the transfer commencing time of the next job and/or the temporal suspension of the transferring operation, etc. can be controlled so that the data transferring operation of the next job is completed at the time when the print processing of the preceding job is finalized, it becomes possible for the output apparatus 10 to commence the printing operation of the next job just after the preceding job is finalized without generating any time lag, while holding the job in the output controlling server 30b during a time period as longer as possible in order to prepare for possible change of the output destination.

Although the embodiments of the present invention have been described in the foregoing, the scope of the present invention is not limited to the exemplified embodiment. The modifications and additions of/to the disclosed embodiments, devised by a skilled person without departing from the spirit and scope of the invention, should be also included in the scope of the present invention.

For instance, in the embodiment described in the foregoing, the output destination folder 71 is provided for every output apparatus 10, and the job folder 72 is created in the output destination folder 71 so as to correlate the job with the output apparatus 10. However, any other method could be employed for correlating the job with the output apparatus 10. For instance, it is also applicable that the apparatus ID of the output destination of the job concerned is registered in the job folder 72.

Further, in the first embodiment, when the output destination is changed, the job status information of the original output destination is changed to “Cancel”, and then, the job is deleted at the time when the job information transmitting request is received from the output apparatus 10. However, the system could be so constituted that the output controlling server 30 notifies the output destination apparatus of the cancellation of the job when changing the output destination, and the job for the original output destination is deleted in the output controlling server 30. In this case, the change processing of the output destination becomes possible by conducting such a procedure that includes the steps of; moving the job folder 72, existing in the output destination folder 71 corresponding to the original output destination, to the other output destination folder 71 corresponding to the changed output destination; and changing the job ID, etc. to the new ones notified from the new output destination changed.

Still further, in the embodiment described in the foregoing, the output instruction and/or the output destination changing instruction of the job are/is outputted by conducting the dragging and dropping operation on the layout screen. However, the operations to be conducted in the information processing terminal device 20 are not limited to the above. For instance, an operation for selecting the output destination from the list of the apparatuses would be also applicable for this purpose.

Still further, when the output controlling server 30 calculates the data transfer timing as described in the second embodiment, it is not necessary to reserve the output operation for the output apparatus 10. The system could be so constituted that all setting items, such as an output order of the jobs, output timings of the jobs, etc., are controlled in the site of the output controlling server 30b.

Yet further, although, in the second embodiment, the controlling operations are conducted so that the transferring operation of the next job does not completed before the print processing of the preceding job is finalized, due to the temporal suspension of the transfer commencing time, the transferring operation, etc., and completes with a time lag as shorter as possible from the finalization of the preceding job, it is also applicable, for instance, that the timing of the completion of the transferring operation is adjusted by controlling the transferring velocity. In other words, when setting the transfer commencing time, it is also applicable to conduct such a controlling operation for decreasing the transferring rate so that the completion time of the transferring operation is delayed from its initial setting by time tx, by delaying the transfer commencing time or temporarily suspending the transferring operation. Further, it is also applicable that the transfer commencing time is established as needed (for instance, just after the finalization of the transferring operation of the preceding job, etc.), and only a final part of the data in the transferring object are reserved without transferring them, and then, when receiving the notification of print finalization of the preceding job from the output apparatus 10, a small amount of reserved data are transmitted to the output apparatus 10. According to the above, only a small amount of time lag, necessary for transferring the small amount of the data concerned, would be required.

According to the data outputting system and the output controlling server embodied in the present invention, since the data outputting system is so constituted that the job is held within the output controlling server until the implementation of the job concerned is enabled in the output apparatus designated as the output destination of the job, it becomes possible to conduct various kinds of changing operations in regard to the job as the processing on the output controlling server, during the time period in which the concerned job is retained in the output controlling server. For instance, in the operation for changing the output destination, it becomes unnecessary for the user to conduct such cumbersome operations that the user should once delete the introduced job from the currently designated output apparatus, and then, introduce the same job again into another output apparatus. Accordingly, it becomes possible for the user, who operates the information processing terminal device, to easily change the output destination of the job, already outputted to the output apparatus, to another output destination desired.

While the preferred embodiments of the present invention have been described using specific term, such description is for illustrative purpose only, and it is to be understood that changes and variations may be made without departing from the spirit and scope of the appended claims.

What is claimed is:

1. An output controlling server, to which an information processing terminal device and a plurality of output apparatuses are coupled through a network, comprising:
a communication section to receive a job and an output instruction for designating a specific output apparatus, being one of the plurality of output apparatuses, as an output destination of the job from the information processing terminal device;
a storage to store the job received by the communication section while correlating the job with output destination information representing the specific output apparatus designated by the output instruction; and
a control section to control managing and communicating operations of the job;
wherein the control section controls a transferring operation for transferring the job to the specific output apparatus, corresponding to a time when an implementation for processing the job is enabled in the specific output apparatus represented by the output destination information, which is correlated with the job stored in the storage.

2. The output controlling server of claim 1,
wherein, when the control section receives an output destination change instruction for changing the output destination of the job stored in the storage from a first output apparatus, serving as the specific output apparatus, to a second output apparatus, the control section changes an original status of the job stored in the storage to a revised status in which the job is correlated to output destination information representing the second output apparatus.

3. The output controlling server of claim 2,
wherein the control section employs a folder, created for every output apparatus, as the output destination information, so as to correlate the job with the output destination information by storing the job into the folder; and
wherein the control section moves or duplicates the job into a second folder, serving as the folder corresponding to the second output apparatus, from a first folder, serving as the folder corresponding to the first output apparatus, in order to correlate the job with the output destination information representing the second output apparatus.

4. The output controlling server of claim 3,
wherein, when the control section completes operations for moving or duplicating the job into the second folder, corresponding to the second output apparatus, from the first folder, corresponding to the first output apparatus, the control section deletes the job stored in the first folder, corresponding to the first output apparatus.

5. The output controlling server of claim 1,
wherein the control section controls the specific output apparatus designated as the output destination of the job, so as to reserve an outputting operation of the job stored in the storage.

6. The output controlling server of claim 1,
wherein the control section controls the transferring operation for transferring a second job to the specific output apparatus, so that the transferring operation for transferring the second job to the specific output apparatus is finalized at a time when an output processing for a first job is completed in the specific output apparatus.

7. The output controlling server of claim 1,
wherein the control section calculates a predicted completion time of an output processing for a first job transferred into the specific output apparatus; and
wherein the control section controls the transferring operation for transferring a second job to the specific output apparatus, so that the specific output apparatus commences the transferring operation for transferring the second job, to be transferred next to the first job, before the predicted completion time arrives, and the transferring operation is finalized just at the predicted completion time calculated or after the predicted completion time arrives.

8. The output controlling server of claim 1,
wherein the control section calculates both a predicted completion time of an output processing for a first job transferred into the specific output apparatus and a predicted transferring time interval for transferring a second job, to be transferred next to the first job, into the specific output apparatus; and
wherein the control section establishes a time, preceding to the predicted completion time by the predicted transferring time interval, as a transfer commencing time of the second job, so as to control a commencement of the transferring operation for transferring the second job to the specific output apparatus, corresponding to the transfer commencing time established.

9. The output controlling server of claim 8,
wherein the control section derives the first predicted completion time from a total sum of a first predicted time interval necessary for developing processing of the first job and a second time interval necessary for other processing in the specific output apparatus; and
wherein, when a notification of completing a developing operation for the first job is received after the first predicted time interval has elapsed, the transfer commencing time is delayed or the transferring operation is suspended, by a time interval between a time when the notification of completing the developing operation is received and a time when the first predicted time interval elapses.

10. The output controlling server of claim 2, further comprising:
a display storage to store display data, based on which an operating screen, including terminal device identifying information for identifying each of the plurality of output apparatuses and data identifying information corresponding to the job, is displayed, in it;
wherein the output instruction or the output destination change instruction can be generated, based on such a user's operation that user drags and drops the data identifying information onto the terminal device identifying information within the operating screen.

11. The output controlling server of claim 10,
wherein the operating screen includes an apparatus layout image for indicating an arrangement of the plurality of output apparatuses, and icons, displayed within the apparatus layout image, for indicating the terminal device identifying information.

12. A data outputting system, comprising:
an information processing terminal device;
a plurality of output apparatuses; and
an output controlling server;
wherein the information processing terminal device, the plurality of output apparatuses and the output controlling server are coupled to each other through a network; and
wherein the information processing terminal device includes:
a first communication section to transmit a job and an output instruction for designating a specific output apparatus, being one of the plurality of output apparatuses, as an output destination of the job to the output controlling server;
while, the output controlling server includes:
a second communication section to receive the job and the output instruction from the information processing terminal device;
a storage to store the job received by the second communication section while correlating the job with output destination information representing the specific output apparatus designated by the output instruction; and
a control section to control managing and communicating operations of the job; and
wherein the control section controls a transferring operation for transferring the job to the specific output apparatus, corresponding to a time when an implementation for processing the job is enabled in the specific output apparatus represented by the output destination information, which is correlated with the job stored in the storage.

13. The data outputting system of claim 12,
wherein the information processing terminal device transmits an output destination change instruction for changing the output destination of the job stored in the storage from a first output apparatus, serving as the specific output apparatus, to a second output apparatus; and
wherein, when the control section receives the output destination change instruction, the control section changes an original status of the job stored in the storage to a revised status in which the job is correlated to output destination information representing the second output apparatus.

14. The data outputting system of claim 12,
wherein the control section employs a folder, created for every output apparatus, as the output destination information, so as to correlate the job with the output destination information by storing the job into the folder; and
wherein the control section moves or duplicates the job into a second folder, serving as the folder corresponding to the second output apparatus, from a first folder, serving as the folder corresponding to the first output apparatus, in order to correlate the job with the output destination information representing the second output apparatus.

15. The data outputting system of claim 14,
wherein, when the control section completes operations for moving or duplicating the job into the second folder, corresponding to the second output apparatus, from the first folder, corresponding to the first output apparatus, the control section deletes the job stored in the first folder, corresponding to the first output apparatus.

16. The data outputting system of claim 12,
wherein the control section controls the specific output apparatus designated as the output destination of the job, so as to reserve an outputting operation of the job stored in the storage.

17. The data outputting system of claim 16,
wherein, receiving a reservation request of the outputting operation of the job from the output controlling server, the specific output apparatus registers the job as a reserved job, and then, sends a reservation ID of the reserved job back to the output controlling server; and
wherein the control section stores the reservation ID sent back from the specific output apparatus while correlating the reservation ID with the job; and
wherein the specific output apparatus transmits a request of sending job information including the reservation ID to the output controlling server at the time when the implementation for processing the job is enabled; and
wherein, receiving the request of sending job information from the specific output apparatus, the control section transfers the job, correlated to the reservation ID, to the specific output apparatus.

18. The data outputting system of claim 12,
wherein the control section controls the transferring operation for transferring a second job to the specific output apparatus, so that the transferring operation for transferring the second job to the specific output apparatus is finalized at a time when an output processing for a first job is completed in the specific output apparatus.

19. The data outputting system of claim 12,
wherein the control section calculates a first predicted completion time of an output processing for a first job transferred into the specific output apparatus; and
wherein the control section controls the transferring operation for transferring a second job, to be transferred next to the first job, to the specific output apparatus, so that the transferring operation for transferring the second job is commenced in the specific output apparatus before the first predicted completion time arrives, and is completed just at the first predicted completion time or after the first predicted completion time arrives.

20. The data outputting system of claim 12,
wherein the control section calculates both a predicted completion time of an output processing for a first job transferred into the specific output apparatus and a predicted transferring time interval for transferring a second job, to be transferred next to the first job, into the specific output apparatus; and
wherein the control section establishes a time, preceding to the first predicted completion time by the predicted transferring time interval, as a transfer commencing time of the second job, so as to control a commencement of the transferring operation for transferring the second job to the specific output apparatus, corresponding to the transfer commencing time established.

21. The data outputting system of claim 20,
wherein the specific output apparatus notifies the output controlling server of a completion of a developing operation for the first job; and
wherein the control section derives the predicted completion time from a total sum of a first predicted time interval necessary for developing processing of the first job and a second time interval necessary for other processing in the specific output apparatus; and
wherein, when a notification of completing the developing operation for the first job is received after the first predicted time interval has elapsed, the transfer commencing time is delayed or the transferring operation is suspended, by a time interval between a time when the notification of completing the developing operation is received and a time when the first predicted time interval elapses.

22. The data outputting system of claim 12,
wherein the information processing terminal device further includes:
a display device to display an operating screen including terminal device identifying information for identifying each of the plurality of output apparatuses and data identifying information corresponding to the job; and
wherein the output controlling server further includes:
a display storage to store display data, based on which the display device displays the operating screen, in it; and
wherein the output instruction or the output destination change instruction can be generated, based on such a user's operation that user drags and drops the data identifying information onto the terminal device identifying information within the operating screen.

23. The data outputting system of claim 22,
wherein the operating screen includes an apparatus layout image for indicating an arrangement of the plurality of output apparatuses, and icons, displayed within the apparatus layout image, for indicating the terminal device identifying information.
